(19) United States
(12) Patent Application Publication
(10) Pub. No.: US 2007/0010641 A1
(43) Pub. Date: Jan. 11, 2007

(54) Catalyst systems for elastomeric compositions

(76) Inventors: Ashok Adur, Westlake, OH (US); Zengli Fu, Mount Pocono, PA (US); Roger W. Avakian, Aurora, OH (US)

Correspondence Address: POLYONE CORPORATION, 33587 WALKER ROAD, AVON LAKE, OH, 44012, US

(21) Appl. No.: 10/567,292

(22) PCT Filed: Jul. 19, 2004
(86) PCT No.: PCT/US04/23203

§ 371 Date: Feb. 6, 2006

Related U.S. Application Data
(60) Provisional application No. 60/493,128, filed on Aug. 7, 2003.

(51) Int. Cl. C08F 4/00

(52) U.S. Cl. 526/237

(57) ABSTRACT

A catalyst system is disclosed for use with elastomeric compositions, such as thermoset elastomers or thermoplastic elastomers. The catalyst system comprises at least one phenolic resin and at least one other ingredient selected from the group consisting of a non-transition metal halide and a nanoclay, provided that when the ingredient is nanoclay, the phenolic resin is brominated. Optionally, the catalyst system can include at least one acid or at least one hydrogen halide scavenger, or both. The catalyst system avoids the use of tin-containing materials, reducing environmental concerns. Elastomers and their preparation in the presence of the catalyst system are also disclosed, including the preparation of white elastomers.

### CLAIM OF PRIORITY

This application claims priority from U.S. Provisional Patent Application Ser. No. 60/493,128 bearing Attorney Docket Number 12003008 and filed on Aug. 7, 2003.

### FIELD OF THE INVENTION

This invention relates to catalyst systems for preparing elastomeric compositions.

### BACKGROUND OF THE INVENTION

In the past several decades, the use of polymers has transformed the world. Polymer science has rapidly evolved to make thousands of different thermoplastic and thermosetting products within the four corners of polymer physics: thermoplastic plastics, thermoplastic elastomers, thermoset plastics, and thermoset elastomers.

No large scale production of any polymer can rest on current processing conditions. Reduction of cost, improvement of productivity, delivery of better performing, lower cost products all drive the polymer science industry. The situation is no different for elastomers.

### SUMMARY OF THE INVENTION

What is needed in the art of preparing elastomeric compositions is a catalyst system that decreases processing time for such compositions without deleterious affecting the performance of such compositions.

The present invention solves that problem in the art by providing a new catalyst system that reduces reaction time with comparable or improved composition properties.

One aspect of the invention is a catalyst system for preparing an elastomeric composition, comprising at least one phenolic resin, at least one ingredient selected from the group consisting of a non-transition metal halide and a nanoclay, optionally at least one acid and optionally at least one hydrogen halide scavenger, wherein when the ingredient is nanoclay, the phenolic resin is brominated. Preferably, when the ingredient is a non-transition metal halide, the phenolic resin is non-brominated. Preferably, the non-transition metal halide is a chloride.

Another aspect of the invention is a thermoplastic elastomer preparable using the above-described catalyst system.

Another aspect of the invention is a method of making an elastomeric composition using the above-described catalyst system.

One advantage of the present invention is avoidance of tin-containing catalyst systems to prepare elastomers, reducing environmental concerns.

Another advantage is the ability to produce white elastomers.

Features and advantages of the catalyst systems of the present invention and their use will become apparent from disclosure of the embodiments and extensive examples of the invention, below.

### Embodiments of the Invention

### DEFINITIONS

An “elastomeric composition” is generally a composition that can behave as either a thermoplastic elastomer or a thermoset elastomer depending upon the ratio of the hard and soft segments, the ratio of the thermoplastic to the elastomer phase and/or the extent of crosslinking. In addition to behaving as such, the elastomeric composition also retains elastomeric or rubbery properties.

A “thermoplastic elastomer” (TPE) is generally a polymer or blend of polymers that can be processed and recycled in the same way as a conventional thermoplastic material, yet having properties and performance similar to that of an elastomer or rubber at the service temperature at which it is used. Notably, blends (or alloys) of plastic and elastomeric rubber have become increasingly important in the production of thermoplastic elastomers, particularly for the replacement of thermoset rubber or flexible polyvinyl chloride (PVC) in various applications.

A “thermoplastic vulcanizate” (TPV) is a type of thermoplastic elastomer, where the elastomer phase is partially or completely crosslinked, vulcanized or cured, such that the TPV can be processed and recycled in the same way as a conventional thermoplastic material, yet retaining properties and performance similar to that of a vulcanized elastomer or rubber at the service temperature at which it is used. TPVs are becoming increasingly important in the production of high performance thermoplastic elastomers, particularly for the replacement of thermoset rubber in various applications.

“Dynamic crosslinking” or “dynamic vulcanization” is a process whereby at least one elastomer and a curative for the elastomer are masticated and/or mixed intensively during cure of the elastomer. The term “dynamic” indicates that the composition is subjected to shear forces during the curing step as contrasted with “static” vulcanization wherein the vulcanizable composition is immobile (in fixed relative space) during the curing step. By use of dynamic vulcanization, obtaining elastoplastic (thermoplastic elastomeric) compositions is facilitated when the blend contains the proper proportions of thermoplastic and elastomer components. Examples of dynamic vulcanization can be found in U.S. Pat. Nos. 3,037,954; 3,806,558; 4,104,210; 4,116,914; 4,130,535; 4,141,863; 4,141,878; 4,173,556; 4,207,404; 4,271,049 4,287,324; 4,288,570; 4,299,931; 4,311,628 and 4,338,413.

Catalyst System

In most embodiments, catalyst systems of the invention comprise at least one phenolic resin, at least one non-transition metal halide, and optionally at least one acid. Other suitable components can also be included in catalyst systems of the invention. For example, at least one hydrogen halide scavenger (e.g., a zinc compound such as zinc oxide) may be preferred for certain applications. Further, in certain embodiments, by using nanoclay in the catalyst system, the non-transition metal halide can be omitted. Each of these components is described in further detail below.

Phenolic Resin

Any suitable phenolic resin or combinations thereof can be used in catalyst systems of the invention. The phenolic resin can be halogenated or non-halogenated, but it is preferred that the phenolic resin be non-brominated, since the benefits of the invention are illustrated more vividly when a non-brominated phenolic resin is used.

Advantageously, when non-brominated phenolic resins are used, detrimental effects on color and odor of the compositions in which the catalyst systems are used to prepare are minimized. Ideally, elastomeric compositions having a base color that is consistent and easily adapted for the desired application are desirable. Preparation of such elastomeric compositions is promoted when using catalyst systems of the invention.

Suitable phenolic resins can be obtained by a variety of methods understood by those of skill in the art. For example, they may be obtained by condensation of a halogen-substituted phenol, C₁-C₁₀ alkyl substituted phenol (preferably substituted in the para position), or an unsubstituted phenol with an aldehyde (preferably formaldehyde) in an alkaline medium or by condensation of bi-functional phenol dialcohols. Suitable phenolic resins can also be obtained by halogenation of an alkyl-substituted phenol.

For certain applications, it is preferred to use phenolic resins with methylol groups. Such phenolic resins include polymeric phenols containing up to ten, preferably no more than three, benzene rings.

Phenolic resins with methylol groups can be obtained by a variety of methods understood by those of skill in the art. For example, a suitable non-halogen containing phenolic resin with methylol groups can be prepared by the condensation of an unsubstituted phenol, a C₁-C₁₂ alkyl-para-substituted phenol or a halogen-substituted phenol with an aldehyde, preferably formaldehyde, in an alkaline medium or by condensation of phenol dialcohols.

Particularly preferred are phenolic resins derived from dimethylol phenol substituted with C₄-C₁₂ alkyl groups, preferably tertiary alkyl groups, in the para-position. Examples of these phenolic resins are described in U.S. Pat. Nos. 2,972,600; 3,093,613; 3,287,440; 3,709,840; 3,211,804; and 4,555,552. Dimethylol phenols substituted with C₅-C₁₀ alkyl in the para-position are especially preferred.

A wide variety of suitable phenolic resin is commercially available. Examples of such phenolic resins include those sold under the trade designations SP-1045, SP-1045, and SP-1056 (all available from Schenectady International Inc.; Schenectady, N.Y.); and Bakelite 6438K (Bakelite AG; Iserlohn, Germany). Other companies, including Sovereign Chemical Company (Akron, Ohio) and Ashland Specialty Chemical Company (Dublin, Ohio, which uses the Arofene™ trade designation) also supply phenolic resins.

Halide

Any suitable halide or combinations thereof can be used in catalyst systems of the invention. The halide, when used in conjunction with the phenolic resin, activates curing of elastomeric compositions for which the catalyst system is designed.

Non-transition metal halides are preferably used in the present invention. Conventionally, when transition metal halides are used in catalyst systems, they require the presence of another compound (such as zinc oxide) to form the halide (e.g., zinc chloride) in situ therefrom. That is not the case with non-transition metal halides used in catalyst systems of the present invention.

As long as the halide does not comprise significantly corrosive elements, it is suitable for use in the invention. For example, halides that contain heavy metals such as mercury, tin (e.g., tin (II)), or lead can cause corrosion if present in significant amounts. Corrosion can cause extensive and significant damage to processing equipment used to prepare thermoplastic elastomers. Corrosive—elements may also pose environmental concerns, which require time—and money-intensive consideration. Therefore, it is preferred that the halide is essentially free of such heavy metals. Non-transition metal halides are particularly preferred. These halides comprise an inorganic metal other than a transition metal (i.e., a transition metal is a metal of Groups III, IV, V, and VI of the Periodic Table of the Elements that has an atomic number greater than 20). The effective use of these halides was previously unknown. Thus, the invention provides many benefits from the use of non-transition metal halides, one of which is greater formulation latitude.

The inorganic metal halide may be, for example, a chloride, a bromide, or a metal silicate salt of halide (e.g., those derived from natural and synthetic clays). Preferably, the halide is a chloride or bromide. Non-limiting examples of such halides include aluminum chloride, calcium chloride, magnesium chloride, potassium chloride, sodium chloride, aluminum bromide, calcium bromide, magnesium bromide, potassium bromide, and sodium bromide. Of these, chlorides are preferred, most preferably magnesium chloride.

Optional Acid

Any suitable acid or combinations thereof can be used in catalyst systems of the invention. In certain embodiments, the use of an acid advantageously increases the curing rate of the catalyst system and processing efficiency of the elastomeric composition.

When used, preferably, the acid is aliphatic or aromatic, with the use of at least one aliphatic acid being especially desirable. Non-limiting examples of suitable types of acids include acetic acid, benzoic acid, citric acid, oleic acid, salicylic acid, and stearic acid, with citric, oxalic, and stearic acids being especially preferred.

See U.S. Pat. No. 4,835,204 for a description of the use of a carboxylic aromatic acid, salicylic acid, when preparing elastomeric compositions from polyolefins and EPDM terpolymers.

Optional Hydrogen Halide Scavenger

Optionally, a hydrogen halide scavenger can be used in the catalyst system for further processing efficiency. Hydrogen halide scavengers include a complexing ion that is capable of solubilizing the hydrogen halide cation produced by the phenolic resin in the catalyst system. Some zinc compounds are well known hydrogen halide scavengers, such as for example, zinc acetate dehydrate, hydrated zinc acetylacetone, hydrated zinc catecholate, zinc stearate, and zinc oxide. For certain applications, the use of at least one of a zinc oxide or zinc stearate can function as a preferred hydrogen halide scavenger.

While a hydrogen halide scavenger is not necessary, in certain embodiments of the invention it may have beneficial effects. For example, in certain embodiments of the invention exemplified in the examples following, the addition of zinc oxide in compositions of the invention did not significantly change the reaction rate, but it was seen to have a potential effect on the color of the product depending on the quality of zinc oxide used. The purer the grade and whiter the color of zinc oxide used, the whiter a product is generally obtainable.

Elastomeric Compositions

Catalyst systems of the invention are useful for preparing elastomeric compositions whereby an elastomer or elastomeric phase is cured. In further embodiments, elastomeric compositions may also comprise optional processing oils, other additives, or combinations thereof.

While the catalyst system is useful in curing elastomers without the presence of other base components such as thermoplastics, elastomeric compositions of the invention are preferably thermoplastic elastomers (which include thermoplastic vulcanizates). Thermoplastic elastomers generally comprise at least one thermoplastic and at least one elastomer. In further embodiments, thermoplastic elastomers may also comprise optional processing oils, compatibilizers, other additives, or combinations thereof One particularly preferred thermoplastic elastomer is a thermoplastic olefin elastomer (TPE-O). TPE-Os preferably comprise at least one thermoplastic polyolefin and at least one elastomer.

Thermoplastic

Any suitable thermoplastic material may be used as the thermoplastic component of thermoplastic elastomers of the invention. Thermoplastics are generally materials that can be molded or otherwise shaped and reprocessed at temperatures at least as great as their softening or melting point. Polyolefins are preferred thermoplastic materials.

Polyolefins are a fundamental building block in polymer science and engineering because of their low cost, high volume production based on petrochemical production. Non-limiting examples of polyolefins useful as thermoplastic olefins of the invention include homopolymers and copolymers of lower a-olefins such as 1-butene, 1-pentene, 1-hexene, 2-methyl-1-propene, 3-methyl-1-pentene, 4-methyl-1-pentene, and 5-methyl-1-hexene, as well as ethylene, butylene, and propylene, with the homopolymer of propylene being preferred.

Polypropylene (PP) has thermoplastic properties best explained by a recitation of the following mechanical and physical properties: a rigid semi-crystalline polymer with a modulus of about 300 MPa to about 1 GPa, a yield stress of about 5 MPa to about 35 MPa, and an elongation to ranging from about 10% to about 1,000%.

Selection of a polyolefin from commercial producers uses Melt Flow Rate (MFR) properties. The MFR can range from about 0.05 to about 1400, and preferably from about 0.5 to about 70 g/10 min at 230° C. under a 2.16 kg load. For polypropylene, that MFR should be from about 0.5 to about 70 and preferably from about 1 to about 35 g/10 min at 230° C. under a 2.16 kg load.

Non-limiting examples of polypropylene useful for the present invention are those commercially available from suppliers such as Dow Chemicals, Huntsman Chemicals, ExxonMobil Chemicals, Basell Polyolefins, and BP Amoco.

Elastomer

Any suitable elastomer can be cured using the catalyst systems of the invention. It is preferred that the elastomer has a substantially saturated hydrocarbon backbone chain which causes the copolymer to be relatively inert to ozone attack and oxidative degradation, but that the elastomer also has side-chain unsaturation available for curing. For example, natural rubber, polyisoprene rubber, styrene-butadiene rubber, polybutadiene rubber, nitrile rubber, butyl rubber, ethylene-propylene-diene rubber (EPDM), ethylene-octene copolymers, and other elastomers can be effectively and advantageously cured according to the invention. Some elastomers, however, which have unsaturation in their backbone and/or side chain unsaturation, can also be effectively and advantageously used according to the present invention.

When preparing TPE-Os, the use of olefinic elastomers is especially preferred. Olefinic elastomers are especially useful in TPE-Os because of their reasonable cost for properties desired. Of these elastomers, EPDM is preferred because it is a fundamental building block in elastomer science and engineering due to its low cost and high volume, as it is a commodity synthetic rubber since it is based on petrochemical production. EPDM encompasses copolymers of ethylene, propylene, and at least one non-conjugated diene.

The thermosetting properties of EPDM are best explained by the following mechanical and physical properties: low compression set, the ability to be oil extended to a broad range of hardness, and good thermal stability.

Selection of an olefinic elastomer from commercial producers uses Mooney Viscosity properties. The Mooney Viscosity for olefinic elastomer can range from about 1 to about 500, and preferably from about 20 to about 200 ML 1+4@100° C. For EPDM, that Mooney Viscosity should be from about 20 to about 100, and preferably from about 40 when the elastomer is extended with oil. When liquid EPDM systems are desired, however, lower viscosity is preferred.

Non-limiting examples of EPDM useful for the present invention are those commercially available from companies such as Bayer, DuPont Dow Elastomers, Uniroyal Chemicals (now part of Crompton Corporation), ExxonMobil Chemicals, and others.

The elastomer itself may be provided in a variety of forms. For example, rubbers are available in liquid, powder, bale, shredded, or pelletized form. The form in which the uncured elastomer is mixed with the catalyst system influences the type of processing equipment and parameters needed. Those of ordinary skill in the art are readily familiar with processing elastomers in these various forms and will make the appropriate selections. For example, when the elastomer is supplied in bale form, a shredder is generally used to break up the elastomer into a shredded form prior to its addition to the processing equipment in which the curing reaction occurs.

Optional Processing Oil

The use of processing oils to effect oil extension of the elastomer is well known in the art. In the production of thermoplastic elastomers, for example, it is often desirable to include an oil to extend the elastomer portion of the composition. This oil extension provides the properties of lower hardness and better compression set while reducing cost of the elastomer to achieve the same volume.

Oil can be a separate ingredient in the elastomeric composition or can be a part of the elastomer component itself, depending on the commercial source of elastomer supply. Non-limiting examples of oils suitable for optional use in the present invention include aromatic, paraffinic, and naphthenic mineral oils. Concentration of oil in the elastomeric composition will generally range from about 0 to about 300 phr, and preferably from about 0 to about 150 phr, but may vary outside of these ranges as understood by those of ordinary skill in the art.

Optional Compatibilizer

In preferred embodiments, a compatibilizer is used as a component of thermoplastic elastomers, particularly TPE-Os, prepared according to the present invention. When selected accordingly, the compatibilizer can diffuse into the olefinic elastomer phase of TPE-Os when in a molten state. With subsequent crystallization upon cooling, the compatibilizer links domains of cured olefinic elastomer particles dispersed in a polyolefin matrix. In the production of TPEs, for example, it is often desirable and advantageous to include a compatibilizer to promote synergistic integration of the two distinct components—the thermoplastic and elastomer—when attempting to provide certain improved performance properties as compared to those observed with either component alone.

When used in preparing TPE-Os, a minor amount of a copolymer compatibilizer can effectively and further compatibilize an otherwise compatible thermoplastic elastomer system. “Minor amount” means a minor weight percentage of compatibilizer, relative to the olefinic elastomer. Desirably, the minor weight percentage ranges from about 0.5 to about 10, and preferably from about 1 to about 5.0. Expressed alternatively in parts per hundred parts of rubber (“phr”), the minor amount of compatibilizer ranges from about 0.5 to about 50 phr, and preferably, from about 1.0 to about 10 phr, depending on the olefinic elastomer selected.

Preferably, copolymer compatibilizers are selected from olefinic and styrenic copolymers, such as ethylene styrene copolymers; extended polyolefin technology copolymers; ethylene alpha olefin copolymers; styrenic block copolymers, such as styrene ethylene butylene styrene; ethylene acrylate copolymers; ethylene vinyl acetate copolymers; and combinations thereof. The copolymers can be random, pseudo-random, block, or any other suitable form in structure.

Other Optional Additives

Any suitable additive may be included in desired amounts in thermoplastic elastomers of the invention. For example, fillers (e.g., calcined clay, kaolin clay, talc, silicates, and carbonates), pigments and colorants (e.g., carbon black), flame retardants, antioxidants, conductive particles, UV-inhibitors, stabilizers, coupling agents (e.g., silanes, maleated polyolefins, zirconates and titanates), plasticizers, lubricants, antiblocking agents, antistatic agents, waxes, foaming agents, and combinations thereof may be beneficially used in certain applications. Those of ordinary skill in the art will readily understand selection and use of such additives.

Further, it was discovered that the use of nanoclay facilitated faster gelation times in certain compositions of the invention. In those embodiments, a non-transition metal halide was not always needed in the catalyst system to achieve the desired effects (e.g., in those embodiments where a brominated phenolic resin was used in the catalyst system). Thus, the use of nanoclay to increase gelation time and provide more flexibility in formulation was found to be desirable according to certain aspects of the invention.

Thermoplastic Elastomers

As noted above, thermoplastic elastomers are preferred elastomeric compositions of the present invention. Preferably, the thermoplastic and elastomer components are selected such that they are generally compatible. The phrase “generally compatible” means that the cured elastomer phase of the thermoplastic elastomer has good adhesion to, and is finely dispersed in, a continuous thermoplastic phase. The average elastomer particle size in generally compatible systems can range from as small as physically possible to about 10 μm in diameter. Desirably, the particle size of the elastomer particles can range from about 0.1 μm to about 5 μm in diameter, and preferably from about 0.1 μm to about 2 μm in diameter in particularly preferred compatible thermoplastic elastomer systems.

The ratio of thermoplastic to elastomer components varies depending on the intended application. The selection of the types and amounts of these components is understood by those of ordinary skill in the art.

Preparation of Elastomeric Compositions

Selection of Components

An appropriate amount of the catalyst system can be used to cure the elastomer or elastomer phase in forming an elastomeric composition. The type and amount of catalyst system is selected such that it will effectively cure the elastomer or elastomer phase to the desired degree in the desired amount of time. Accordingly, catalyst systems are designed with a view toward their intended application.

Generally, within the catalyst system, the phenolic resin is used in an amount suitable to effect the desired cure of the elastomer. In general, the ratio of amount of the phenolic resin used in relation to the amount of the uncured elastomer depends on the curing rate desired. A higher proportion of the phenolic resin will facilitate faster curing rates. Preferably, the amount of the phenolic resin used is about 0.5 to about 25 percent by weight based on total weight of the uncured elastomer. More preferably, the amount of the phenolic resin used is about 1 to about 15 percent by weight based on total weight of the uncured elastomer. Even more preferably, the amount of the phenolic resin used is about 2 to about 10 percent by weight based on total weight of the uncured elastomer.

Within the catalyst system, the halide is used in an amount suitable to effect the desired cure of the elastomer. Preferably, the amount of the halide used is about 0.5 to about 20 percent by weight based on total weight of the uncured elastomer. More preferably, the amount of the halide used is about 1 to about 10 percent by weight based on total weight of the uncured elastomer. Even more preferably, the amount of the halide used is about 2 to about 8 percent by weight based on total weight of the uncured elastomer. As discussed above, however, the halide was not found to be necessary when a nanoclay additive was used in certain embodiments of the catalyst system (e.g., in those embodiments where a brominated phenolic resin was used in the catalyst system).

Within the catalyst system, the optional acid is used in an amount suitable to effect the desired cure of the elastomer. Preferably, the amount of the acid used is up to about 20 percent by weight based on total weight of the uncured elastomer. More preferably, the amount of the acid used is about 0.5 to about 10 percent by weight based on total weight of the uncured elastomer. Even more preferably, the amount of the acid used is about 1 to about 5 percent by weight based on total weight of the uncured elastomer.

Within the catalyst system, the optional hydrogen halide scavenger is used in an amount suitable to effect the desired cure of the elastomer. Preferably, the amount of the hydrogen halide scavenger used is up to about 10 percent by weight based on total weight of the uncured elastomer. More preferably, the amount of the hydrogen halide scavenger used is about 0.1 to about 5 percent by weight based on total weight of the uncured elastomer. Even more preferably, the amount of the hydrogen halide scavenger used is about 0.2 to about 2.0 percent by weight based on total weight of the uncured elastomer.

The catalyst system can be mixed with a liquid elastomer composition that is curable to an elastomeric composition such as a thermoset rubber (also referred to as a thermoset elastomer). The catalyst system can also be mixed with a liquid elastomer composition to form an elastomeric composition to which a thermoplastic is later added in order to make thermoplastic elastomers. Alternatively, the catalyst system can be used to form a cured thermoplastic elastomer without the need for further processing. Similarly, the catalyst system can be used to form a cured thermoset elastomer without the need for forther processing.

Selection ofProcessing Equipment and Processing of the Elastomeric Composition

Processing of the elastomeric composition can occur via batch or continuous processing. Using either batch or continuous processing, components of the elastomeric composition can be mixed and heated to react in a single piece of equipment or the components can be mixed and heated to react in multiple pieces of equipment. Economies of scale for production lead to a preference for continuous processing, whereby the elastomeric compositions can be formed into desired shapes and sizes continuously with their preparation.

In one embodiment of a batch process, elastomeric compositions can be prepared by mixing the components in a first piece of equipment. Mechanical mixers, such as Banbury-type, Brabender-type, roll mill, Buss, dry turbo mixers and the like are suitable for this purpose.

In one embodiment, all base components (i.e., elastomer and thermoplastic, if used) of the elastomeric composition can be charged into the mixer at a temperature ranging from about 170° C. to about 210° C., and preferably from about 175° C. to about 185° C. Mixing proceeds at a pace ranging from about 10 to about 100 rpm (revolutions per minute), and preferably from about 75 to about 85 rpm for a duration ranging from about 1 to about 5 minutes, and preferably from about 2 to about 4 minutes. Thereafter, a suitable amount of the catalyst system is added, ranging from about 1 to about 8 phr, and preferably from about 2 to about 5 phr. The mixture is then allowed to mix for an additional period of time, ranging from about 1 to about 10, and preferably from about 6 to about 8 minutes to permit dynamic vulcanization of the elastomer.

The elastomeric composition is then transferred to other equipment for formation into the desired shape and size. For example, plugs of the cured elastomeric composition can be removed from the mixer and compression-molded into, for example, a 7.6×15.2×0.31 cm (3×6×0.125 inch) plaque mold at a temperature ranging from about 170° C. to about 210° C., and preferably from about 175 to about 185° C. The plug material can be held under no pressure for 30 seconds, after which pressure can be increased to 1,100 kN force over a period of about 3 minutes. After application of pressure of 1,100 kN force for 4 minutes, the samples can be cooled to ambient temperature while pressure is maintained.

During continuous processing, the components can be first mixed in a suitable mixer without substantial application of heat. Mechanical mixers, such as Banbury-type, Brabender-type, roll mill, Buss, dry turbo mixers and the like are suitable for this purpose. In this embodiment, the mixed components are then conveyed continuously to another piece of equipment, where the mixture is heated to form a cured elastomeric composition. For example, reactive extrusion equipment is suitable for this purpose.

Reactive extrusion allows for dynamic vulcanization to occur, which is preferably when preparing thermoplastic elastomers. Dynamic vulcanization can advantageously reduce processing time and throughput. However, methods other than dynamic vulcanization can be utilized to prepare elastomeric compositions of the invention. For example, the elastomer can be cured in the absence of the thermoplastic, powdered, and mixed with the thermoplastic resin at a temperature above the melting or softening point of the thermoplastic resin to form a thermoplastic elastomer.

A wide variety of reactive extrusion equipment can be employed for reacting the mixture. Preferred is a twin screw co-rotating extruder with a length-to-diameter (L/D) ratio ranging from about 24 to about 84, and preferably from about 32 to about 64. Utilization of relatively low L/D ratio (e.g, 44 or less) extruders is possible, advantageously, with certain preferred embodiments of the invention.

To achieve reaction, and hence curing, of the elastomeric composition, the mixture is typically heated to a temperature substantially equal to or great then the softening point of any thermoplastic employed and for a sufficient time to obtain a composition of the desired homogeneity and crosslinking of the elastomer. For example, the extrusion profile for a preferred PP/EPDM reactive extrusion can be a flat 190° C. profile and 500 rpm. The reaction components can be fed into the reaction extruder at 27 kg/hr (60 lb/hr) using, for example, a 25-mm twin screw extruder. Lower rates may be used, for example, where the residence time needs to be higher in order to complete the crosslinking reaction desired. The actual rate and residence times needed are dependent upon the total amount of elastomer, the type of elastomer (including consideration of the diene content in the elastomer), the ratio of the components in the catalyst system, and the total amount of catalyst, as well as the L/D of the extruder and the precise screw design and configuration.

The components of the elastomeric composition may be added to the processing equipment in any suitable amount and in any suitable order. Preferably, however, elastomer and thermoplastic components are generally added to the processing equipment prior to addition of the catalyst system. For example, when a thermoplastic elastomer is being prepared, the thermoplastic is preferably mixed with the elastomer and processing oil prior to addition of the catalyst system. The catalyst system may be added, preheated and injected, directly into the melt stream or into the main hopper where the premixed other components reside.

If used, a suitable amount of suitable processing oil (e.g., mineral oil and the like) is preferably added to the elastomer prior to addition of the catalyst system. Other additives are generally added after addition of the foregoing components of the catalyst system.

Usefulness of the Invention

When using catalyst systems of the invention, processing time, and hence throughput of elastomeric compositions, are capable of being beneficially increased. Higher throughput facilitates lower production costs. A higher throughput can also allow for the use of a smaller extruder during processing, i.e., one having a lower length-to-diameter (L/D) ratio, which can significantly decrease capital costs associated with preparation of elastomeric compositions.

The increase in throughput, obtainable by the improved curing efficiency, is obtainable without the use of corrosive catalyst systems. Thus, production costs are further reduced due to the decrease in physical degradation (as compared to those seen previously when using certain conventional catalyst systems). This advantage is particularly noticeable for those catalyst systems of the present invention using preferred non-brominated phenolic resins.

Another advantage of this invention is that a whiter elastomeric composition can be produced as compared to those elastomeric compositions conventionally prepared. Using catalyst systems of the invention facilitates achievement of this often desirable feature.

A further advantage of the invention is that, if desired, an elastomeric composition can be prepared with no “heavy metal” content (e.g., that from titanium or tin compounds), which content is often present in many conventional elastomeric compositions, especially in thermoplastic vulcanizates. This is very desirable, particularly in Europe, due to environmental consciousness.

Elastomeric compositions of the invention can be formed into a variety of articles as well understood by those of ordinary skill in the art. For example, thermoplastic elastomers can be reprocessed, such as by being pressed, compression-molded, injection-molded, blow-molded, thermoformed, calendared, or extruded into final articles. When reprocessing thermoplastic elastomers of the invention, the material is generally heated to a temperature of at least the softening or melting point of the thermoplastic component of the elastomeric composition in order to facilitate further forming into desired articles of various shapes and sizes.

Further embodiments of the invention are described in the following non-limiting Examples.

### EXAMPLES

General Experimental Testing Procedures

The following experimental testing procedures were used in the “General Experimental Materials Examples” below, unless noted otherwise.

pH Measurement

The pH of a sample was measured using pH paper called “Hydrion Papers” (obtained from Micro Essential Laboratory; Brooklyn, N.Y.). The pH paper was placed into a beaker of the sample to be measured. Comparing the color change observed on the paper so placed to an interpretative chart provided with the pH paper, the sample's pH was determined. The pH is reported in the following examples as “pH of the Mixture before Reaction” or “pH of Product,” depending on the type of sample analyzed.

Color Measurement

A sample's color was measured using a Spectraflash™ 600 spectrometer (Datacolor International; Lawrenceville, N.J.) color meter. This color meter provides a readout for the values of “L,” “a,” “b,” and “YI” according to the test method. Visual observations with the unaided human eye were also used to determine the color of certain product samples contained in a glass beaker.

Determination of Values for L, a, b, and YI

ASTM E313-00, “Standard Practice for Calculating Yellowness and Whiteness Indices from Instrumentally Measured Color Coordinates,” was used to determine “YI”—the yellowness index of the resulting composition. This yellowness index indicates the degree of departure of an object color from colorless or from a preferred white, toward yellow. Thus, a smaller “YI” value generally indicates a whiter product. Determination of opponent-color coordinates, “L,” “a,” and “b,” is well known to those of skill in the art with reference to ASTM documentation. For example, those coordinates are referenced in ASTM E284-03, “Terminology of Appearance.” In general, higher “L” values indicate a whiter product. Typically, values of “a” approximating zero also indicate a whiter product. Similarly, lower “b” values are generally further indicative of a whiter product.

Gelation Time Measurement

A stopwatch was used to measure the total time required for a sample to gel to a single phase, as understood by one of ordinary skill in the art. The total time measured is reported as the “Time for Gelation.”

General Experimental Materials Examples

Unless noted otherwise, the following materials were used as indicated in the examples described below.

TABLE 1

| Trade | | |
|---|---|---|
| Designation or | | |
| Abbreviation | Description | Source |
| Aluminum | Aluminum chloride (at | Fisher Scientific Company; Fair Lawn, NJ |
| Chloride | least 98% pure solid) | |
| Bakelite ™ AG | Phenolic resin | Bakelite AG; Gennaer Strasse 2-4; 58642; |
| 6204 K | | Iserlohn, Germany |
| Britol ™ 550 PO | White paraffin oil | Witco, a division of Crompton Corp.; Petrolia, |
| | | PA |
| Calcined Kaolin | Calcined kaolin clay | Burgess Pigment Company; Sandersville, GA |
| Clay | | |
| Calcium | Calcium chloride (at least | Fisher Scientific Company; Fair Lawn, NJ |
| Chloride | 98% pure solid) | |
| Calcium Stearate | Calcium stearate | Sovereign Chemicals; Akron, OH |
| Citric Acid | Citric Acid (at least 98% | Aldrich Chemical Company, Inc.; Milwaukee, |
| | pure) | WI |
| ESI (DE 200.01) | Ethylene-styrene | Dow Chemical Company; Freeport, TX |
| | interpolymer | |
| Fluorad ™ FC- | Perfluorobutyric acid | 3M Company (Industrial Chemical Products |
| 23 | (CAS 375-22-4) | Division); St. Paul, MN |
| Hifax ™ CA10A | Reactor-grade | Basell North America Inc., Elkton, MD |
| | thermoplastic elastomeric | (www.basell.com) |
| | olefin with >50% | |
| | elastomer | |
| Irganox ™ 1010 | Phenolic antioxidant | Ciba Specialty Chemicals North America, |
| | | Tarrytown, NY (www.cibasc.com) |
| Irganox ™ B-225 | 1:1 mixture of phenolic | Ciba Specialty Chemicals North America, |
| | antioxidant and phosphite | Tarrytown, NY (www.cibasc.com) |
| Kaydol ™ BT-90 | White mineral oil (CAS | Crompton Corporation - Uniroyal Chemical; |
| | 8042-47-5) | Middlebury, CT (www.cromptoncorp.com) |
| Kraton ™ G | Triblock copolymer | Kraton Polymers; Houston, TX |
| 1652 | thermoplastic rubber with | (www.kraton.com) |
| | polystyrene end blocks | |
| | and a rubbery | |
| | poly(ethylene-butylene) | |
| | mid block | |
| Lowilite ™ 55 | Benzotriazole-type light | Great Lakes Chemical Corporation, Terra |
| | absorber | Haute, IN |
| Magnesium | Magnesium chloride (at | Aldrich Chemical Company, Inc.; Milwaukee, |
| chloride | least 98% pure) | WI |
| Nanomer ™ 1.44 | Nanoclay | Nanocor; Arlington Heights, IL |
| PA | | |
| Nordel ™ IP | Metallocene-based | DuPont Dow Elastomers L.L.C.; Wilmington, |
| 4770 | EPDM with 70% | DE |
| | ethylene content, a | |
| | Mooney Viscosity of 70 ML | |
| | (1 + 4) at 125° C., and | |
| | an ENB diene content of | |
| | 4.5% | |
| Nordel ™ IP | Metallocene-based | DuPont Dow Elastomers L.L.C.; Wilmington, |
| 4770P | EPDM with 70% | DE |
| | ethylene, 5% ENB diene | |
| | and a Mooney Viscosity | |
| | of 47 ML (1 + 4) at 125° C. | |
| Nordel ™ MG | Metallocene-based | DuPont Dow Elastomers L.L.C.; Wilmington, |
| 47085 | EPDM with 69% | DE |
| | ethylene content, a | |
| | Mooney Viscosity of 85 ML | |
| | (1 + 4) at 125° C., an | |
| | ENB diene content of | |
| | 4.5%, and a carbon black | |
| | content of 25 phr | |
| Nordel ™ MG | Metallocene-based | DuPont Dow Elastomers L.L.C.; Wilmington, |
| 47130 | EPDM with 69% | DE |
| | ethylene content, a | |
| | Mooney Viscosity of 130 ML | |
| | (1 + 4) at 125° C., an | |
| | ENB diene content of | |
| | 4.5%, and a carbon black | |
| | content of 25 phr | |
| Oxalic Acid | Oxalic Acid (at least 98% | Aldrich Chemical Company, Inc.; Milwaukee, |
| | pure) | WI |
| Paralux ™ | Paraffin oil | ChevronTexaco Corporation; San Ramon, CA |
| 6001R | | (www.chevron.com/prodserv/paralux) |
| Penacolite ™ | Resorcinol- | Indspec Chemical Corporation; Harmarville, |
| B-20-S | formaldehyde-styrene | PA |
| | resin (Lot No. 2440) | (www.indspec-chem.com) |
| PP 10-15 MFI | Polypropylene | Exxon Mobil Chemicals; Baytown, TX, or |
| | homopolymer flakes | other supplier |
| | having a MFR of 10-15 g/ | |
| | 10 min at 230° C. under | |
| | a 2.16 kg load | |
| PP1024E4 | Polypropylene | Exxon Mobil Chemicals; Baytown, TX |
| | homopolymer with a | |
| | MFR of 10-14 g/10 min | |
| | at 230° C. under a 2.16 kg | |
| | load | |
| Pro-fax ™ 6823 | Polypropylene | Basell North America Inc., Elkton, MD |
| | homopolymer with a | (www.basell.com) |
| | MFR of 0.5 g/10 min at | |
| | 230° C. under a 2.16 kg | |
| | load | |
| Ribetak ™ R | Phenolic resin | Loos & Dilworth, Inc.; Bristol, PA |
| 7530 | | (www.loosanddilworth.com) |
| Royalene ™ | EPDM containing 75 phr | Crompton Corporation - Uniroyal Chemical; |
| X5494 | oil, prepared from a 70/30 | Middlebury, CT (www.cromptoncorp.com) |
| | weight/weight ratio of | |
| | ethylene to propylene and | |
| | 4.7% ENB diene, and | |
| | having a net Mooney | |
| | Viscosity of 45 ML (1 + 4) | |
| | @ 125° C. | |
| Salicylic Acid | Salicylic Acid (at least | Aldrich Chemical Company, Inc.; Milwaukee, |
| | 98% pure) | WI |
| Sodium | Nucleating agent | Velsicol Chemical Corp. (Rosemont, IL) or |
| Benzoate | | other suppliers |
| SP-1044 | Octylphenol heat reactive | Schenectady International Inc.; Schenectady, |
| | phenolic resin | NY |
| | | (www.siigroup.com/products) |
| SP-1045 | Octylphenol heat reactive | Schenectady International Inc.; Schenectady, |
| | phenolic resin | NY |
| | | (www.siigroup.com/products) |
| SP-1055 | brominated heat reactive | Schenectady International Inc.; Schenectady, |
| | phenolic resin | NY (www.siigroup.com/products) |
| Stannous | Stannous chloride (at | Fisher Scientific Company; Fair Lawn, NJ |
| Chloride | least 98% pure solid) | |
| Stearic Acid | Stearic acid (at least 98% | Fisher Scientific Company; Fair Lawn, NJ |
| | pure solid) | |
| Supersoft | Soft reactor grade TPO | Basell North America Inc., Elkton, MD |
| Hifax ™ 7320 | | (www.basell.com) |
| Tinuvin ™ 327 | UV-stabilizer | Ciba Specialty Chemicals North America, |
| | | Tarrytown, NY (www.cibasc.com) |
| Tinuvin ™ P | UV-stabilizer | Ciba Specialty Chemicals North America, |
| | | Tarrytown, NY (www.cibasc.com) |
| Titanium | Titanium dioxide | Tioxide Canada Inc.; Quebec, Canada |
| Dioxide | | |
| Trilene ™ 65 | Liquid ethylene | Ciba Specialty Chemicals North America, |
| | propylene diene rubber | Tarrytown, NY (www.cibasc.com) |
| | (EPDM) polymer that has | |
| | an ethylene/propylene | |
| | ratio of 50/50, that | |
| | contains 10.5% | |
| | dicyclopentadiene | |
| | (DCPD) by weight, and a | |
| | weight average molecular | |
| | weight of 49,000 | |
| Trilene ™ 77 | High ethylene EPDM | Crompton Corporation - Uniroyal Chemical; |
| | having a low molecular | Middlebury, CT (www.cromptoncorp.com) |
| | weight | |
| Ultranox ™ 641 | Phosphite antioxidant | Crompton Corporation - Uniroyal Chemical; |
| | | Middlebury, CT (www.cromptoncorp.com) |
| Zinc Oxide | Zinc oxide (at least 98% | Akrochem Corporation; Akron, OH |
| | pure solid) | |
| Zinc Stearate | Zinc stearate | H.L. Blanchford Ltd.; Montreal, Quebec |
| 201 | | |

### Examples 1-7

In each of these examples, 2 grams of Trilene™ 65 liquid EPDM were added to a ten milliliter glass beaker, followed by the addition of 2 grams of Paralux™ 6001R paraffin oil thereto. The remaining materials indicated in Table 2 below were then added to the mixture. The respective amounts (based on parts by weight of the composition) of each material in the mixture thus formed are also indicated in Table 2 below. Note that the phenolic resin was stored in a freezer until its addition to the mixture.

The pH of the mixture was measured according to the pH Measurement test method, modified as noted in Table 3, and is recorded in Table 3 below. The mixture was then heated on a Fisher Thermix™ Stirring Hot Plate; Model 210M, to the temperature indicated in Table 3. While heating, the mixture was manually and gently stirred with a standard stirring rod.

After the mixture reached the indicated temperature, the pH was measured again according to the modified pH Measurement test method. Further, the color of the product was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 3.

TABLE 2

| | Parts by Weight (%) | | | | | | |
|---|---|---|---|---|---|---|---|
| Material | Ex. 1 | Ex. 2 | Ex. 3 | Ex. 4 | Ex. 5 | Ex. 6 | Ex. 7 |
| Trilene ™ 65 | 50 | 50 | 50 | 50 | 50 | 50 | 50 |
| Paralux ™ 6001R | 50 | 50 | 50 | 50 | 50 | 50 | 50 |
| Zinc Oxide | 1 | 1 | 1 | — | — | — | — |
| Zinc Stearate 201 | — | — | — | 1 | 1 | 1 | 1 |
| SP-1044 | 4 | 4 | 4 | 4 | 4 | 4 | 4 |
| Magnesium Chloride | 2 | 2 | 2 | 2 | 2 | 2 | 2 |
| Stearic Acid | — | — | — | — | — | 1 | — |
| Fluorad ™ FC-23 | — | — | — | — | — | — | 1 |

TABLE 3

| | Ex. 1 | Ex. 2 | Ex. 3 | Ex. 4 | Ex. 5 | Ex. 6 | Ex. 7 |
|---|---|---|---|---|---|---|---|
| Temperature (° C.) | 180 | 190 | 200 | 180 | 190 | 190 | 190 |
| pH of Mixture Before Reaction* | 5 | 5 | 5 | 5 | 5 | 5 | 2 |
| Color of Product | beige | beige | beige | beige | beige | beige | dk. |
| | | | | | | | Brown |
| L | 56.36 | 50.94 | 51.02 | 32.60 | 28.21 | 30.86 | 26.99 |
| a | 4.82 | 5.39 | 6.36 | 5.05 | 2.35 | 3.40 | 2.09 |
| b | 30.12 | 28.68 | 28.08 | 15.45 | 7.25 | 9.71 | 4.12 |
| YI | 57.35 | 60.79 | 59.68 | 31.88 | 18.81 | 21.02 | 6.61 |
| Time for Gelation (min.) | 11.00 | 8.50 | 8.00 | 8.50 | 5.50 | 6.50 | 5.50 |
| pH of Product* | 4 | 3 | 3 | 3 | 3 | 3 | 3 |

*1 drop or equivalent gel in 5 ml water

### Examples 8-16

A different phenolic resin was used in Example 8-16, as compared to Examples 1-7. In each of Examples 8-16, 2 grams of Trilene™ 65 liquid EPDM were added to a ten milliliter glass beaker, followed by the addition of 2 grams of Paralu™ 6001R paraffin oil thereto. The remaining materials indicated in Table 4 below were then added to the mixture. The respective amounts (based on parts by weight of the composition) of each material in the mixture thus formed are also indicated in Table 4 below. Note that the phenolic resin was stored in a freezer until its addition to the mixture.

The pH of the mixture was measured according to the pH Measurement test method and is recorded in Table 5 below. The mixture was then heated on a Fisher Thermix™ Stirring Hot Plate; Model 210M, to the temperature indicated in Table 5. While heating, the mixture was manually and gently stirred with a standard stirring rod.

After the mixture reached the indicated temperature, the pH was measured again according to the pH Measurement test method. Further, the color of the product was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 5.

TABLE 4

| | Parts by Weight (%) | | | | | | | | |
|---|---|---|---|---|---|---|---|---|---|
| Material | Ex. 8 | Ex. 9 | Ex. 10 | Ex. 11 | Ex. 12 | Ex. 13 | Ex. 14 | Ex. 15 | Ex. 16 |
| Trilene ™ 65 | 50 | 50 | 50 | 50 | 50 | 50 | 50 | 50 | 50 |
| Paralux ™ 6001R | 50 | 50 | 50 | 50 | 50 | 50 | 50 | 50 | 50 |
| Zinc Stearate 201 | 1 | 2 | 3 | 1 | 2 | 2 | 2 | 2 | 2 |
| Ribetak ™ R 7530 | 4 | 4 | 4 | 4 | 4 | 4 | 4 | 4 | 4 |
| Magnesium Chloride | 2 | 2 | 2 | 3 | 3 | 4 | 1.5 | 1 | 1 |
| Stearic Acid | — | — | — | — | — | — | — | — | 0.5 |
| Fluorad ™ FC-23 | — | — | — | — | — | — | 0.5 | 1 | 0.5 |

TABLE 5

| | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|
| Temperature (° C.) | 180 | 180 | 180 | 180 | 180 | 180 | 180 | 180 | 180 |
| pH of Mixture Before | 5 | 5 | 5 | 5 | 5 | 5 | 5 | 3 | 4 |
| Reaction | | | | | | | | | |
| Color of Product | yellow | yellow | yellow | yellow | yellow | yellow | lt. | dk. | lt. |
| | | | | | | | brown | brown | brown |
| L | 32.41 | 31.15 | 33.55 | 31.87 | 34.70 | 33.49 | 31.73 | 24.56 | 31.53 |
| a | 2.97 | 2.52 | 2.54 | 1.84 | 0.01 | 0.13 | 0.21 | 0.43 | −0.15 |
| b | 11.70 | 10.64 | 14.76 | 8.66 | 10.22 | 9.28 | 9.51 | 4.31 | 8.19 |
| YI | 40.91 | 36.10 | 41.70 | 24.10 | 26.22 | 25.80 | 31.16 | 12.01 | 23.09 |
| Time for Gelation (min.) | 8.00 | 7.00 | 6.50 | 6.50 | 5.50 | 5.00 | 5.00 | 2.00 | 3.50 |
| pH of Product | 3 | 3 | 3 | 3 | 3 | 3 | 3 | 3 | 3 |

### Examples 17-26

In each of Examples 17-26, 2 grams of Trilene™ 65 liquid EPDM were added to a ten milliliter glass beaker, followed by the addition of 2 grams of Paralux™ 6001R paraffin oil thereto. The remaining materials indicated in Table 6 below were then added to the mixture. The respective amounts (based on parts by weight of the composition) of each material in the mixture thus formed are also indicated in Table 6 below. Note that the phenolic resin was stored in a freezer until its addition to the mixture.

The pH of the mixture was measured according to the pH Measurement test method and is recorded in Table 7 below. The mixture was then heated on a Fisher Thermix™ Stirring Hot Plate; Model 210M, to the temperature indicated in Table 7. While heating, the mixture was manually and gently stirred with a standard stirring rod.

After the mixture reached the indicated temperature, the pH was measured again according to the pH Measurement test method. Further, the color of the product was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 7.

TABLE 6

| | Parts by Weight (%) | | | | | | | | | |
|---|---|---|---|---|---|---|---|---|---|---|
| Material | Ex. 17 | Ex. 18 | Ex. 19 | Ex. 20 | Ex. 21 | Ex. 22 | Ex. 23 | Ex. 24 | Ex. 25 | Ex. 26 |
| Trilene ™ 65 | 50 | 50 | 50 | 50 | 50 | 50 | 50 | 50 | 50 | 50 |
| Paralux ™ 6001R | 50 | 50 | 50 | 50 | 50 | 50 | 50 | 50 | 50 | 50 |
| Zinc Stearate 201 | 2 | 2 | 2 | 2 | 2 | 2 | 2 | 2 | 2 | 2 |
| Ribetak ™ R 7530 | 4 | 4 | 4 | 4 | 4 | 4 | 4 | 4 | 4 | 3 |
| Penacolite ™ | — | — | — | — | — | — | — | — | — | 1 |
| B-20-S | | | | | | | | | | |
| Magnesium Chloride | 1.50 | 1.75 | 2.00 | 1.75 | 2.00 | 2.00 | 1.75 | 1.50 | 1.50 | 1.50 |
| Stearic Acid | — | — | — | — | — | 0.50 | 0.50 | 0.50 | 0.50 | 0.50 |
| Fluorad ™ FC-23 | 0.50 | 0.50 | 0.50 | 0.25 | 0.25 | 0.50 | 0.25 | 0.50 | 0.25 | 0.25 |

TABLE 7

| | Ex. 17 | Ex. 18 | Ex. 19 | Ex. 20 | Ex. 21 | Ex. 22 | Ex. 23 | Ex. 24 | Ex. 25 | Ex. 26 |
|---|---|---|---|---|---|---|---|---|---|---|
| Temperature (° C.) | 180 | 180 | 180 | 180 | 180 | 180 | 180 | 180 | 180 | 180 |
| pH of Mixture Before | 5 | 5 | 5 | 5 | 5 | 5 | 5 | 5 | 5 | 5 |
| Reaction | | | | | | | | | | |
| Color of Product | yellow | yellow | yellow | yellow | yellow | yellow | yellow | yellow | yellow | red |
| L | 27.51 | 28.28 | 25.62 | 22.89 | 30.44 | 31.82 | 34.70 | 36.80 | 36.46 | 32.80 |
| a | 1.02 | −1.43 | 2.87 | 1.87 | 0.76 | −1.54 | −2.57 | −2.79 | −2.52 | 6.10 |
| b | 7.10 | 5.16 | 4.96 | 4.53 | 7.34 | 8.71 | 9.82 | 8.19 | 10.01 | 12.40 |
| YI | 25.78 | 18.94 | 19.33 | 18.94 | 25.05 | 28.47 | 30.07 | 24.64 | 29.66 | 38.02 |
| Time for Gelation (min.) | 5.5 | 6.0 | 5.0 | 5.0 | 6.0 | 4.0 | 4.0 | 2.5 | 3.0 | 2.5 |
| pH of Product | 3 | 4 | 3 | 3 | 3 | 3 | 3 | 4 | 4 | 3 |

### Examples 27-37

A different EPDM was used in this set of examples, as compared to the EPDM used in Examples 1-26. In each of Examples 27-37, 2 grams of Trilene™ 77 liquid EPDM were added to a ten milliliter glass beaker, followed by the addition of 2 grams of Paralux™ 6001R paraffin oil or 2 grams of Kaydol™ BT-90 white mineral oil thereto. The remaining materials indicated in Table 8 below were then added to the mixture. The respective amounts (based on parts by weight of the composition) of each material in the mixture thus formed are also indicated in Table 8 below. Note that the phenolic resin was stored in a freezer until its addition to the mixture.

The pH of the mixture was measured according to the pH Measurement test method and is recorded in Table 9 below. The mixture was then heated on a Fisher Thermix™ Stirring Hot Plate; Model 210M, to the temperature indicated in Table 9. While heating, the mixture was manually and gently stirred with a standard stirring rod.

After the mixture reached the indicated temperature, the pH was measured again according to the pH Measurement test method. Further, the color of the product was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 9. Additionally, the value of (3L−a+b−YI)/3, another value that is indicative of the whiteness of a material, is also reported in Table 9.

TABLE 8

| | Parts by Weight (%) | | | | | | | | | | |
|---|---|---|---|---|---|---|---|---|---|---|---|
| Material | Ex. 27 | Ex. 28 | Ex. 29 | Ex. 30 | Ex. 31 | Ex. 32 | Ex. 33 | Ex. 34 | Ex. 35 | Ex. 36 | Ex. 37 |
| Trilene ™ 77 | 50 | 50 | 50 | 50 | 50 | 50 | 50 | 50 | 50 | 50 | 50 |
| Kaydol ™ BT-90 | 50 | — | — | — | — | — | — | — | — | — | — |
| Paralux ™ 6001R | — | 50 | 50 | 50 | 50 | 50 | 50 | 50 | 50 | 50 | 50 |
| Zinc Oxide | 2 | — | — | — | — | — | — | — | — | — | — |
| Zinc Stearate 201 | — | 2 | 2 | 2 | 2 | 2 | 2 | 2 | 2 | 2 | 2 |
| SP-1045 | 3 | — | — | — | — | — | — | — | — | — | — |
| Ribetak ™ R | — | 4 | 4 | 4 | 4 | 4 | 4 | 4 | 4 | 4 | 3 |
| 7530 | | | | | | | | | | | |
| Penacolite ™ | — | — | — | — | — | — | — | — | — | — | 1 |
| B-20-S | | | | | | | | | | | |
| Magnesium | 2.00 | 1.50 | 1.75 | 2.00 | 1.75 | 2.00 | 2.00 | 1.75 | 1.50 | 1.50 | 1.50 |
| Chloride | | | | | | | | | | | |
| Stearic Acid | — | — | — | — | — | — | 0.50 | 0.50 | 0.50 | 0.50 | 0.50 |
| Fluorad ™ FC-23 | — | 0.50 | 0.50 | 0.50 | 0.25 | 0.25 | 0.50 | 0.25 | 0.50 | 0.25 | 0.25 |

TABLE 9

| | Ex. 27 | Ex. 28 | Ex. 29 | Ex. 30 | Ex. 31 | Ex. 32 | Ex. 33 | Ex. 34 | Ex. 35 | Ex. 36 | Ex. 37 |
|---|---|---|---|---|---|---|---|---|---|---|---|
| Temperature | 180 | 180 | 180 | 180 | 180 | 180 | 180 | 180 | 180 | 180 | 180 |
| (° C.) | | | | | | | | | | | |
| Preheat | No | No | No | No | No | No | No | No | No | No | No |
| pH of | 5 | 5 | 5 | 5 | 5 | 5 | 5 | 5 | 5 | 5 | 5 |
| Mixture | | | | | | | | | | | |
| Before | | | | | | | | | | | |
| Reaction | | | | | | | | | | | |
| Color of | white | yellow | yellow | yellow | yellow | yellow | yellow | yellow | yellow | yellow | lt. |
| Product | | | | | | | | | | | orange |
| L | 72.74 | 51.38 | 38.88 | 48.23 | 39.96 | 33.07 | 43.32 | 45.65 | 45.02 | 44.21 | 43.89 |
| a | −4.57 | −3.23 | −3.49 | −3.59 | −3.78 | −2.40 | −3.06 | −2.97 | −2.71 | −2.87 | 5.56 |
| b | 8.28 | 8.36 | 9.64 | 10.10 | 11.10 | 9.30 | 8.69 | 5.81 | 7.82 | 7.59 | 14.87 |
| YI | 15.38 | 19.94 | 27.55 | 24.93 | 30.70 | 29.50 | 23.39 | 15.53 | 20.68 | 20.36 | 37.39 |
| (3L − a + b − YI) | 71.90 | 48.60 | 34.07 | 44.48 | 34.69 | 27.14 | 39.44 | 43.40 | 41.64 | 40.91 | 34.53 |
| Time for | 3.0 | 3.0 | 3.0 | 3.0 | 3.0 | 3.0 | 2.5 | 2.5 | 2.5 | 2.5 | 2.5 |
| Gelation | | | | | | | | | | | |
| (min.) | | | | | | | | | | | |
| pH of Product | 4 | 4 | 4 | 4 | 4 | 4 | 4 | 4 | 4 | 4 | 4 |

### Examples 38-40 and Comparative Examples C1-C4

A different non-brominated phenolic resin and a brominated phenolic resin were used in this set of examples, as compared to the non-brominated phenolic resins used in Examples 1-37. In each of Examples 38-40 and Comparative Examples C1-C4, 2 grams of Trilene™ 77 liquid EPDM were added to a ten milliliter glass beaker, followed by the addition of 2 grams of Kaydol™ BT-90 white mineral oil thereto. The remaining materials indicated in Table 10 below were then added to the mixture. As can be seen from Table 10, Comparative Example C1 utilized stannous chloride, a heavy transition metal halide, as a component of the catalyst system therein. The respective amounts (based on parts by weight of the composition) of each material in the mixture thus formed are also indicated in Table 10 below. Note that the phenolic resin was stored in a freezer until its addition to the mixture.

The pH of the mixture was measured according to the pH Measurement test method and is recorded in Table 11 below. The mixture was then heated on a Fisher Thermix™ Stirring Hot Plate; Model 210M, to the temperature indicated in Table 11. While heating, the mixture was manually and gently stirred with a standard stirring rod.

After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 11. Additionally, the value of (3L−a+b−YI)/3 is also reported in Table 11.

TABLE 10

| | Parts by Weight (%) | | | | | | |
|---|---|---|---|---|---|---|---|
| | Ex. | Ex. | Ex. | Comparative | Comparative | Comparative | Comparative |
| Material | 38 | 39 | 40 | Example C1 | Example C2 | Example C3 | Example C4 |
| Trilene ™ 77 | 50 | 50 | 50 | 50 | 50 | 50 | 50 |
| Kaydol ™ BT-90 | 50 | 50 | 50 | 50 | 50 | 50 | 50 |
| Zinc Oxide | — | — | — | 2.0 | 1.25 | 2.0 | — |
| Zinc Stearate 201 | 2.0 | 2.0 | 2.0 | — | — | — | 2.0 |
| SP-1055 | 2.5 | 2.5 | 2.5 | — | 2.5 | 2.5 | 2.5 |
| SP-1045 | — | — | — | 3.0 | — | — | — |
| Stannous chloride | — | — | — | 2.0 | — | — | — |
| Calcined Kaolin | — | — | — | 10.0 | — | — | — |
| Clay | | | | | | | |
| Nanomer ™ 1.44 | 2.0 | 5.0 | 10.0 | — | — | — | — |
| PA | | | | | | | |

TABLE 11

| | | | | Comparative | Comparative | Comparative | Comparative |
|---|---|---|---|---|---|---|---|
| | Ex. 38 | Ex. 39 | Ex. 40 | Example C1 | Example C2 | Example C3 | Example C4 |
| Temperature (° C.) | 180 | 180 | 180 | 180 | 180 | 180 | 180 |
| pH of Mixture | 5 | 5 | 5 | 5 | 5 | 5 | 5 |
| Before Reaction | | | | | | | |
| Color of Product | yellow | yellow | yellow | white | white | white | yellow |
| L | 38.64 | 35.10 | 41.39 | 72.42 | 69.28 | 68.83 | 39.89 |
| a | −6.29 | −6.66 | −6.21 | −0.95 | −4.35 | −3.48 | −3.34 |
| b | 14.82 | 18.83 | 26.21 | 4.29 | 8.95 | 9.88 | 9.20 |
| YI | 40.16 | 51.39 | 60.27 | 8.21 | 17.17 | 18.92 | 26.00 |
| (3L − a + b − YI)/3 | 32.29 | 26.47 | 32.11 | 71.43 | 67.99 | 66.98 | 35.40 |
| Time for Gelation | 2.5 | 2.5 | 2.5 | 3.0 | 3.0 | 2.5 | 3.0 |
| (min.) | | | | | | | |
| pH of Product | 4 | 4 | 4 | 4 | 4 | 4 | 4 |

### Examples 41-52

This set of examples illustrates the effects from adding an acid, salicylic acid, to the catalyst system as well as other components. In each of Examples 41-52, 2 grams of Trilene™ 77 liquid EPDM were added to a ten milliliter glass beaker, followed by the addition of 2 grams of Kaydol™ BT-90 white mineral oil thereto. The remaining materials indicated in Table 12 below were then added to the mixture. The respective amounts (based on parts by weight of the composition) of each material in the mixture thus formed are also indicated in Table 12 below. Note that the phenolic resin was stored in a freezer until its addition to the mixture.

The pH of the mixture was measured according to the pH Measurement test method and is recorded in Table 13 below. The mixture was then heated on a Fisher Thermix™ Stirring Hot Plate; Model 210M, to the temperature indicated in Table 13. While heating, the mixture was manually and gently stirred with a standard stirring rod.

After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 13. Additionally, the value of (3L−a+b−YI)/3 is also reported in Table 13.

TABLE 12

| | Parts by Weight (%) | | | | | | | | | | | |
|---|---|---|---|---|---|---|---|---|---|---|---|---|
| | Ex. | Ex. | Ex. | Ex. | Ex. | Ex. | Ex. | Ex. | Ex. | Ex. | Ex. | Ex. |
| Material | 41 | 42 | 43 | 44 | 45 | 46 | 47 | 48 | 49 | 50 | 51 | 52 |
| Trilene ™ | 50 | 50 | 50 | 50 | 50 | 50 | 50 | 50 | 50 | 50 | 50 | 50 |
| 77 | | | | | | | | | | | | |
| Kaydol ™ | 50 | 50 | 50 | 50 | 50 | 50 | 50 | 50 | 50 | 50 | 50 | 50 |
| BT-90 | | | | | | | | | | | | |
| Zinc Oxide | 2 | — | — | — | — | — | — | — | — | — | — | — |
| Zinc | — | 2 | 2 | 2 | 2 | 2 | 2 | 2 | 2 | 2 | 2 | 2 |
| Stearate | | | | | | | | | | | | |
| 201 | | | | | | | | | | | | |
| SP-1045 | 3 | 3 | 3 | 3 | 3 | 3 | 3 | 3 | 3 | 3 | 3 | 3 |
| Magnesium | 2.00 | 2.00 | 2.50 | 2.00 | 2.00 | 2.00 | 2.00 | 2.00 | 2.00 | 2.50 | 2.50 | 2.50 |
| Chloride | | | | | | | | | | | | |
| Stearic | — | — | — | 0.50 | — | — | 0.50 | — | — | — | — | — |
| Acid | | | | | | | | | | | | |
| Fluorad ™ | — | — | — | — | 0.50 | — | — | 0.50 | — | — | — | — |
| FC-23 | | | | | | | | | | | | |
| Salicylic | — | — | — | — | — | 0.50 | — | — | 0.50 | 0.50 | 0.50 | 0.50 |
| Acid | | | | | | | | | | | | |
| Titanium | — | — | — | — | — | — | 2.00 | 2.00 | 2.00 | 1.50 | 1.00 | 0.05 |
| Oxide | | | | | | | | | | | | |

TABLE 13

| | Ex. | Ex. | Ex. | Ex. | Ex. | Ex. | Ex. | Ex. | Ex. | Ex. | Ex. | Ex. |
|---|---|---|---|---|---|---|---|---|---|---|---|---|
| | 41 | 42 | 43 | 44 | 45 | 46 | 47 | 48 | 49 | 50 | 51 | 52 |
| Temperature | 180 | 180 | 180 | 180 | 180 | 180 | 180 | 180 | 180 | 180 | 180 | 180 |
| (° C.) | | | | | | | | | | | | |
| pH of | 5 | 5 | 5 | 5 | 3 | 5 | 5 | 5 | 3 | 5 | 5 | 5 |
| Mixture | | | | | | | | | | | | |
| Before | | | | | | | | | | | | |
| Reaction | | | | | | | | | | | | |
| Color of | white | white | white | white | white | white | white | Pinkish | white | white | white | white |
| Product | | | | | | | | white | | | | |
| L | 74.91 | 46.09 | 48.74 | 45.25 | 47.35 | 49.20 | 80.41 | 72.62 | 82.04 | 80.24 | 79.61 | 77.79 |
| a | −1.44 | −1.71 | −1.56 | −1.66 | −2.51 | −2.47 | −1.22 | 1.53 | −1.05 | 1.32 | −1.37 | −1.36 |
| b | 0.97 | −0.10 | −0.33 | 0.05 | 3.79 | 0.04 | 4.09 | 4.41 | 3.34 | 3.75 | 3.37 | 3.27 |
| YI | 0.72 | −0.27 | −0.89 | 0.13 | 10.05 | 0.12 | 7.20 | 8.41 | 5.81 | 6.63 | 6.00 | 5.94 |
| (3L − a + b − YI)/3 | 75.47 | 46.72 | 49.45 | 45.78 | 46.10 | 50.00 | 79.78 | 70.78 | 81.57 | 78.84 | 79.19 | 77.35 |
| Time for | 2.3 | 2.0 | 1.5 | 1.8 | 1.8 | 1.5 | 1.7 | 1.5 | 1.5 | 1.3 | 1.3 | 1.1 |
| Gelation | | | | | | | | | | | | |
| (min.) | | | | | | | | | | | | |
| pH of | 4 | 4 | 4 | 4 | 4 | 4 | 5 | 2 | 4 | 4 | 4 | 4 |
| Product | | | | | | | | | | | | |

As can be seen from Table 13, the addition of salicylic acid reduced the time needed for gelation. Further, the addition of zinc oxide and titanium dioxide separately and together improved the whiteness of the product.

### Examples 53-65

In this set of examples, the effects of preheating the elastomer and phenolic resin with a processing oil to the temperature indicated in Table 15 prior to the addition of the other components indicated in Table 14. In each of Examples 53-65, 2 grams of Trilene™ 77 liquid EPDM were added to a ten milliliter glass beaker, followed by the addition of 2 grams of Kaydol™ BT-90 white mineral oil or 2 grams of Paralux™ 6001R thereto.

In Examples 59-66, this mixture was first heated with stirring to the temperature indicated in Table 15 on a Fisher Thermix™ Stirring Hot Plate, Model 210M. Once the mixture reached the desired temperature, the remaining materials indicated in Table 14 below were added to the mixture. In Examples 53-58, the mixture was not preheated before addition of the remaining materials indicated. The respective amounts (based on parts by weight of the composition) of each material in the mixture thus formed are also indicated in Table 14 below. Note that the phenolic resin was stored in a freezer until its addition to the mixture.

The pH of the mixture was measured according to the pH Measurement test method and is recorded in Table 15 below. The mixture was then heated to, or maintained at, the temperature indicated in Table 15 on a Fisher Thermix™ Stirring Hot Plate; Model 210M. While heating, the mixture was manually and gently stirred with a standard stirring rod.

After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 15. Additionally, the value of (3L−a+b−YI)/3 is also reported in Table 15.

TABLE 14

| | Parts by Weight (%) | | | | | | | | | | | | |
|---|---|---|---|---|---|---|---|---|---|---|---|---|---|
| | Ex. | Ex. | Ex. | Ex. | Ex. | Ex. | Ex. | Ex. | Ex. | Ex. | Ex. | Ex. | Ex. |
| Material | 53 | 54 | 55 | 56 | 57 | 58 | 59 | 60 | 61 | 62 | 63 | 64 | 65 |
| Trilene ™ 77 | 50 | 50 | 50 | 50 | 50 | 50 | 50 | 50 | 50 | 50 | 50 | 50 | 50 |
| Kaydol ™ BT- | 50 | 50 | 50 | 50 | 50 | 50 | 50 | 50 | 50 | 50 | 50 | 50 | — |
| 90 | | | | | | | | | | | | | |
| Paralux ™ | — | — | — | — | — | — | — | — | — | — | — | — | 50 |
| 6001R | | | | | | | | | | | | | |
| Zinc Oxide | — | 0.5 | 1.0 | — | 0.5 | 1.0 | — | 0.5 | 1.0 | — | 0.5 | 1.0 | — |
| Zinc Stearate | 2.0 | 2.0 | 2.0 | 2.0 | 2.0 | 2.0 | 2.0 | 2.0 | 2.0 | 2.0 | 2.0 | 2.0 | 2.0 |
| 201 | | | | | | | | | | | | | |
| SP-1045 | 3.0 | 3.0 | 3.0 | 3.0 | 3.0 | 3.0 | 3.0 | 3.0 | 3.0 | 3.0 | 3.0 | 3.0 | 3.0 |
| Magnesium | 2.5 | 2.5 | 2.5 | 2.5 | 2.5 | 2.5 | 2.5 | 2.5 | 2.5 | 2.5 | 2.5 | 2.5 | 2.5 |
| Chloride | | | | | | | | | | | | | |
| Stearic Acid | — | — | — | 0.5 | 0.5 | 0.5 | — | — | — | 0.5 | 0.5 | 0.5 | — |
| Salicylic Acid | 0.5 | 0.5 | 0.5 | 0.5 | 0.5 | 0.5 | 0.5 | 0.5 | 0.5 | 0.5 | 0.5 | 0.5 | 0.5 |
| Titanium | 0.5 | 0.5 | 0.5 | 0.5 | 0.5 | 0.5 | 0.5 | 0.5 | 0.5 | 0.5 | 0.5 | 0.5 | 0.5 |
| Oxide | | | | | | | | | | | | | |

TABLE 15

| | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| | 53 | 54 | 55 | 56 | 57 | 58 | 59 | 60 | 61 | 62 | 63 | 64 | 65 |
| Temperature | 180 | 180 | 180 | 180 | 180 | 180 | 180 | 180 | 180 | 180 | 180 | 180 | 180 |
| (° C.) | | | | | | | | | | | | | |
| pH of | 5 | 5 | 5 | 5 | 5 | 5 | 5 | 5 | 5 | 5 | 5 | 5 | 5 |
| Mixture | | | | | | | | | | | | | |
| Before | | | | | | | | | | | | | |
| Reaction | | | | | | | | | | | | | |
| Color of | white | white | white | white | white | white | white | white | white | white | white | white | white |
| Product | | | | | | | | | | | | | |
| L | 76.43 | 75.94 | 79.56 | 76.71 | 77.40 | 78.88 | 74.42 | 77.15 | 79.90 | 77.41 | 78.35 | 78.12 | 72.51 |
| a | −1.56 | −1.67 | −1.30 | −1.59 | −1.65 | −1.55 | −2.12 | −1.57 | −1.67 | −1.78 | −1.56 | −1.42 | −1.98 |
| b | 3.32 | 3.47 | 3.05 | 3.23 | 3.75 | 3.66 | 4.24 | 4.12 | 5.53 | 3.59 | 4.04 | 3.79 | 3.22 |
| YI | 6.12 | 6.42 | 5.46 | 5.94 | 6.82 | 6.58 | 7.95 | 7.51 | 9.70 | 6.54 | 7.26 | 6.84 | 6.19 |
| (3L − a + | 76.02 | 75.51 | 79.19 | 76.34 | 76.93 | 78.42 | 73.89 | 76.54 | 79.07 | 77.02 | 77.80 | 77.58 | 72.18 |
| b − YI)/3 | | | | | | | | | | | | | |
| Time for | 1.50 | 1.33 | 1.42 | 1.42 | 1.33 | 1.33 | 0.83 | 0.67 | 0.83 | 0.75 | 0.75 | 0.75 | 0.83 |
| Gelation | | | | | | | | | | | | | |
| (min.) | | | | | | | | | | | | | |
| pH of | 4 | 4 | 4 | 4 | 4 | 4 | 4 | 4 | 4 | 4 | 4 | 4 | 4 |
| Product | | | | | | | | | | | | | |

As can be seen from Table 15, when the elastomer and phenolic resin were preheated prior to addition of the other components of the catalyst system, the time needed for gelation decreased substantially. This is significant because in a production environment, the materials are preheated to melt and mixed in compounding equipment. This preheating simulates the real life situation better than without preheating.

### Examples 66-75

Various aliphatic acids, aromatic acids, and combinations thereof were used in the catalyst systems of these examples. First, however, for each of Examples 66-75, 2 grams of Trilene™ 77 liquid EPDM were added to a ten milliliter glass beaker, followed by the addition of 2 grams of Kaydol™ BT-90 white mineral oil thereto. This mixture was first heated for two minutes, with gentle manual stirring, on a Fisher Thermix™ Stirring Hot Plate; Model 210M, which was maintained at a temperature of 140° C. During this preheating step, the mixture appeared to become a single phase. Thereafter, the remaining materials indicated in Table 16 below were added to the mixture. The respective amounts (based on parts by weight of the composition) of each material in the mixture thus formed are also indicated in Table 16 below. Note that the phenolic resin was stored in a freezer until its addition to the mixture.

The pH of the mixture was measured according to the pH Measurement test method and is recorded in Table 17 below. The expanded mixture was then heated to the temperature indicated in Table 17. After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 17. Additionally, the value of (3L−a+b−YI)/3 is also reported in Table 17.

TABLE 16

| | Parts by Weight (%) | | | | | | | | | |
|---|---|---|---|---|---|---|---|---|---|---|
| Material | Ex. 66 | Ex. 67 | Ex. 68 | Ex. 69 | Ex. 70 | Ex. 71 | Ex. 72 | Ex. 73 | Ex. 74 | Ex. 75 |
| Trilene ™ 77 | 50 | 50 | 50 | 50 | 50 | 50 | 50 | 50 | 50 | 50 |
| Kaydol ™ BT-90 | 50 | 50 | 50 | 50 | 50 | 50 | 50 | 50 | 50 | 50 |
| Zinc Oxide | 2.00 | 2.00 | 2.00 | 2.00 | 2.00 | 2.00 | 2.00 | 2.00 | 2.00 | 2.00 |
| Zinc Stearate 201 | — | — | — | — | — | 1.00 | — | — | — | — |
| SP-1045 | 3.00 | 3.00 | 3.00 | 3.00 | 3.00 | 3.00 | 3.00 | 3.00 | 3.00 | 3.00 |
| Magnesium Chloride | 2.50 | 2.50 | 2.50 | 2.50 | 2.50 | 2.50 | 2.50 | 2.50 | 2.50 | 2.50 |
| Stearic Acid | 0.50 | 0.50 | 0.50 | 0.50 | 0.50 | — | — | — | — | — |
| Salicylic Acid | 0.50 | — | 0.25 | 0.75 | 1.00 | 0.75 | 0.75 | 0.75 | — | — |
| Oxalic Acid | — | — | — | — | — | — | 0.50 | — | 0.50 | — |
| Citric Acid | — | — | — | — | — | — | — | 0.50 | — | 0.50 |
| Titanium Oxide | — | — | — | — | — | 0.25 | 0.50 | 0.50 | 0.50 | 0.50 |

TABLE 17

| | Ex. 66 | Ex. 67 | Ex. 68 | Ex. 69 | Ex. 70 | Ex. 71 | Ex. 72 | Ex. 73 | Ex. 74 | Ex. 75 |
|---|---|---|---|---|---|---|---|---|---|---|
| Temperature (° C.) | 180 | 180 | 180 | 180 | 180 | 180 | 180 | 180 | 180 | 180 |
| pH of Mixture | 5 | 5 | 5 | 5 | 5 | 5 | 5 | 5 | 5 | 5 |
| Before Reaction | | | | | | | | | | |
| Color of Product | white | white | white | white | white | white | white | white | White | white |
| L | 75.61 | 72.89 | 75.34 | 73.63 | 74.63 | 75.03 | 76.32 | 76.92 | 77.59 | 77.50 |
| a | −1.72 | −1.69 | −1.67 | −1.70 | −1.70 | −1.49 | −1.34 | −1.46 | −1.31 | −1.47 |
| b | 3.22 | 1.01 | 1.88 | 1.04 | 2.34 | 2.81 | 3.43 | 2.38 | 3.03 | 3.50 |
| YI | 5.99 | 1.97 | 3.54 | 2.00 | 4.42 | 5.27 | 6.32 | 4.38 | 5.53 | 6.38 |
| (3L − a + b − YI)/3 | 75.26 | 73.13 | 75.34 | 73.88 | 74.50 | 74.71 | 75.80 | 76.74 | 77.19 | 77.03 |
| Time for Gelation | 0.58 | 0.50 | 0.67 | 0.58 | 0.50 | 0.58 | 0.50 | 0.50 | 0.50 | 0.50 |
| (min.) | | | | | | | | | | |
| pH of Product | 4 | 4 | 4 | 4 | 4 | 4 | 4 | 4 | 4 | 4 |

As can be seen from Table 17, substantially lower gelation times and whiter product colors were obtained when using compositions of the present invention.

### Examples 76-85

Various carboxylic acids and amounts thereof were used in the catalyst systems of these examples. First, however, for each of Examples 76-85, 2 grams of Trilene™ 77 liquid EPDM were added to a ten milliliter glass beaker, followed by the addition of 2 grams of Kaydol™ BT-90 white mineral oil thereto. This mixture was first heated for two minutes, with gentle manual stirring, on a Fisher Thermix™ Stirring Hot Plate; Model 210M, which was maintained at a temperature of 140° C. During this preheating step, the mixture appeared to become a single phase. Thereafter, the remaining materials indicated in Table 18 below were added to the mixture. The respective amounts (based on parts by weight of the composition) of each material in the mixture thus formed are also indicated in Table 18 below. Note that the phenolic resin was stored in a freezer until its addition to the mixture.

The pH of the mixture was measured according to the pH Measurement test method and is recorded in Table 19 below. The expanded mixture was then heated to the temperature indicated in Table 19. After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 19. Additionally, the value of (3L−a+b−YI)/3 is also reported in Table 19.

TABLE 18

| | Parts by Weight (%) | | | | | | | | | |
|---|---|---|---|---|---|---|---|---|---|---|
| | Ex. 76 | Ex. 77 | Ex. 78 | Ex. 79 | Ex. 80 | Ex. 81 | Ex. 82 | Ex. 83 | Ex. 84 | Ex. 85 |
| Trilene ™ 77 | 50 | 50 | 50 | 50 | 50 | 50 | 50 | 50 | 50 | 50 |
| Kaydol ™ BT-90 | 50 | 50 | 50 | 50 | 50 | 50 | 50 | 50 | 50 | 50 |
| Zinc Oxide | 2.00 | 2.00 | 2.00 | 2.00 | 2.00 | — | 1.00 | 2.00 | 2.50 | 2.50 |
| Zinc Stearate 201 | — | — | — | — | — | 2.00 | 1.00 | — | — | — |
| SP-1045 | 3.00 | 3.00 | 3.00 | 3.00 | 3.00 | 3.00 | 3.00 | 3.00 | 3.00 | 3.00 |
| Magnesium Chloride | 2.50 | 2.50 | 2.50 | 2.50 | 2.50 | 2.50 | 2.50 | 2.50 | 2.50 | 2.50 |
| Stearic Acid | — | — | — | 0.50 | 0.25 | 0.25 | 0.50 | — | — | — |
| Salicylic Acid | 1.00 | — | — | — | 0.25 | 0.25 | 0.50 | 0.50 | — | — |
| Oxalic Acid | — | 1.00 | — | 0.50 | 0.50 | 0.50 | 0.50 | 0.50 | 0.50 | — |
| Citric Acid | — | — | 1.00 | 0.50 | 0.50 | 0.50 | — | 0.50 | — | 0.50 |
| Titanium Oxide | 1.00 | 1.00 | 1.00 | 2.00 | 2.00 | 2.00 | 2.00 | 2.00 | 2.00 | 2.00 |

TABLE 19

| | Ex. | Ex. | Ex. | Ex. | Ex. | Ex. | Ex. | Ex. | Ex. | Ex. |
|---|---|---|---|---|---|---|---|---|---|---|
| | 76 | 77 | 78 | 79 | 80 | 81 | 82 | 83 | 84 | 85 |
| Temperature (° C.) | 180 | 180 | 180 | 180 | 180 | 180 | 180 | 180 | 180 | 180 |
| pH of Mixture Before | 5 | 5 | 5 | 5 | 5 | 5 | 5 | 5 | 5 | 5 |
| Reaction | | | | | | | | | | |
| Color of Product | white | white | white | white | white | white | white | white | white | white |
| L | 78.93 | 78.83 | 79.57 | 80.15 | 79.51 | 80.44 | 80.43 | 80.29 | 80.55 | 81.00 |
| a | −1.33 | −1.36 | −1.22 | −1.06 | −1.16 | −1.27 | −1.17 | −1.21 | −1.20 | −1.26 |
| b | 3.59 | 4.20 | 3.57 | 3.32 | 3.60 | 3.90 | 3.39 | 3.79 | 3.68 | 3.77 |
| YI | 6.45 | 7.50 | 6.36 | 5.89 | 6.42 | 6.87 | 5.99 | 6.69 | 6.48 | 6.61 |
| (3L − a + b − YI)/3 | 78.42 | 78.18 | 79.05 | 79.65 | 78.96 | 79.87 | 79.95 | 79.73 | 80.02 | 80.47 |
| Time for Gelation | 0.50 | 0.50 | 0.50 | 0.50 | 0.50 | 0.50 | 0.50 | 0.50 | 0.50 | 0.50 |
| (min.) | | | | | | | | | | |
| pH of Product | 4 | 4 | 4 | 4 | 4 | 4 | 4 | 4 | 4 | 4 |

As can be seen from the data in Table 19, much lower gelation times and products with whiter color were obtained with compositions of the invention.

### Examples 86-92

Citric acid was used in the catalyst systems of these examples. First, however, for each of Examples 86-92, 2 grams of Trilene™ 77 liquid EPDM were added to a ten milliliter glass beaker, followed by the addition of 2 grams of Kaydol™ BT-90 white mineral oil thereto. This mixture was first heated for two minutes, with gentle manual stirring, on a Fisher Thermix™ Stirring Hot Plate; Model 210M, which was maintained at a temperature of 140° C. During this preheating step, the mixture appeared to become a single phase. Thereafter, the remaining materials indicated in Table 20 below were added to the mixture. The respective amounts (based on parts by weight of the composition) of each material in the mixture thus formed are also indicated in Table 20 below. Note that the phenolic resin was stored in a freezer until its addition to the mixture.

The pH of the mixture was measured according to the pH Measurement test method and is recorded in Table 21 below. The expanded mixture was then heated to the temperature indicated in Table 21. After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 21. Additionally, the value of (3L−a+b−Yl)/3 is also reported in Table 21.

TABLE 20

| | Parts by Weight (%) | | | | | | |
|---|---|---|---|---|---|---|---|
| Material | Ex. 86 | Ex. 87 | Ex. 88 | Ex. 89 | Ex. 90 | Ex. 91 | Ex. 92 |
| Trilene ™ 77 | 50.00 | 50.00 | 50.00 | 50.00 | 50.00 | 50.00 | 50.00 |
| Kaydol ™ BT-90 | 50.00 | 50.00 | 50.00 | 50.00 | 50.00 | 50.00 | 50.00 |
| Zinc Oxide | 2.00 | 2.00 | 2.00 | 2.00 | 2.00 | 2.00 | 2.00 |
| SP-1045 | 3.00 | 5.00 | 7.00 | 5.00 | 5.00 | 7.00 | 7.00 |
| Magnesium Chloride | 2.50 | 2.50 | 2.50 | 1.50 | 3.50 | 1.50 | 3.50 |
| Citric Acid | 1.00 | 1.00 | 1.00 | 1.00 | 1.00 | 1.00 | 1.00 |
| Titanium Oxide | 1.00 | 1.00 | 1.00 | 1.00 | 1.00 | 1.00 | 1.00 |

TABLE 21

| | Ex. 86 | Ex. 87 | Ex. 88 | Ex. 89 | Ex. 90 | Ex. 91 | Ex. 92 |
|---|---|---|---|---|---|---|---|
| Temperature (° C.) | 180 | 180 | 180 | 180 | 180 | 180 | 180 |
| pH before Reaction | 4 | 4 | 4 | 4 | 4 | 4 | 4 |
| Color of product | white | white | white | white | white | white | white |
| L | 74.48 | 74.73 | 72.59 | 76.81 | 74.72 | 73.41 | 73.03 |
| A | −2.78 | −2.53 | −2.81 | −2.59 | −2.82 | −3.11 | −2.89 |
| B | 7.32 | 6.78 | 7.58 | 7.47 | 7.80 | 8.21 | 7.79 |
| YI | 13.43 | 12.44 | 14.15 | 13.35 | 14.22 | 15.13 | 14.47 |
| (3L − A + B − YI)/3 | 73.37 | 73.69 | 71.34 | 75.71 | 73.52 | 72.14 | 71.77 |
| Time for Gelation (min.) | 1.0 | 0.5 | 0.8 | 1.0 | 1.0 | 0.8 | 0.7 |
| pH product | 3 | 3 | 3 | 3 | 3 | 3 | 3 |

As can be seen from Table 21, compositions of the present invention are capable of facilitating gelation times of less than 45 seconds, while also providing a relatively white product.

### Comparative Example C5 and Examples 93-99

In this set of examples, various halides were used. In Comparative Example C5, a heavy transition metal halide, stannous chloride, was used. In Example 98-99, zinc oxide, a hydrogen halide scavenger, was effectively omitted from the catalyst system.

First, for each of Comparative Example C5 and Examples 93-99, 2 grams of Trilene™ 77 liquid EPDM were added to a ten milliliter glass beaker, followed by the addition of 2 grams of Kaydol™ BT-90 white mineral oil thereto. This mixture was first heated for two minutes, with gentle manual stirring, on a Fisher Thermix™ Stifling Hot Plate; Model 210M, which was maintained at a temperature of 140° C. During this preheating step, the mixture appeared to become a single phase. Thereafter, the remaining materials indicated in Table 22 below were added to the mixture. The respective amounts (based on parts by weight of the composition) of each material in the mixture thus formed are also indicated in Table 22 below. Note that the phenolic resin was stored in a freezer until its addition to the mixture.

The pH of the mixture was measured according to the pH Measurement test method and is recorded in Table 23 below. The expanded mixture was then heated to the temperature indicated in Table 23. After the mixture reached the indicated temperature, the pH was measured again according to the pH Measurement test method. Further, the product's color was measured according to the Color Measurement test method. Values for L, a, b, and YI were then determined using the test method for Determination of Values for L, a, b, and YI. The gelation time was also measured according to the Gelation Time Measurement test method. The results of these measurements are reported in Table 23. Additionally, the value of (3L−a+b−YI)/3 is also reported in Table 23.

TABLE 22

| | Parts by Weight (%) | | | | | | | |
|---|---|---|---|---|---|---|---|---|
| | Comparative | | | | | | | |
| Material | Example C5 | Ex. 93 | Ex. 94 | Ex. 95 | Ex. 96 | Ex. 97 | Ex. 98 | Ex. 99 |
| Trilene ™ 77 | 50.00 | 50.00 | 50.00 | 50.00 | 50.00 | 50.00 | 50.00 | 50.00 |
| Kaydol ™ BT-90 | 50.00 | 50.00 | 50.00 | 50.00 | 50.00 | 50.00 | 50.00 | 50.00 |
| Zinc Oxide | 2.00 | 2.00 | 2.00 | 2.00 | 2.00 | 2.00 | — | — |
| SP-1045 | 7.00 | 3.00 | 3.00 | 3.00 | 3.00 | 3.00 | 3.00 | 3.00 |
| Magnesium Chloride | — | — | 1.50 | — | 1.50 | 1.50 | 1.50 | 1.50 |
| Stannous Chloride | 2.50 | — | — | — | — | — | — | — |
| Aluminum chloride | — | 2.50 | 1.50 | — | — | 1.50 | 1.50 | 1.50 |
| Calcium Chloride | — | — | — | 2.50 | 1.50 | 1.50 | — | — |
| Citric Acid | 1.00 | 1.00 | 1.00 | 1.00 | 1.00 | 1.00 | 1.00 | 1.00 |
| Titanium Oxide | 1.00 | 1.00 | 1.00 | 1.00 | 1.00 | 1.00 | 1.00 | 1.00 |

TABLE 23

| | Comparative | | | | | | | |
|---|---|---|---|---|---|---|---|---|
| | Example C5 | Ex. 93 | Ex. 94 | Ex. 95 | Ex. 96 | Ex. 97 | Ex. 98 | Ex. 99 |
| Temperature (° C.) | 180 | 180 | 180 | 180 | 180 | 180 | 180 | 180 |
| pH before Reaction | 4 | 4 | 4 | 4 | 4 | 4 | 4 | 4 |
| Color of product | white | white | white | white | white | white | white | white |
| L | 75.40 | 75.19 | 73.98 | 75.60 | 75.58 | 75.39 | 78.33 | 78.75 |
| A | −2.73 | −2.67 | −2.39 | −2.91 | −2.36 | −2.70 | −1.50 | −1.45 |
| B | 7.52 | 6.99 | 5.97 | 8.22 | 6.44 | 8.28 | 4.14 | 3.53 |
| YI | 13.64 | 12.76 | 11.11 | 14.81 | 11.75 | 14.95 | 7.44 | 6.35 |
| (3L − A + B − YI)/3 | 74.27 | 74.16 | 73.06 | 74.37 | 74.60 | 74.07 | 77.73 | 78.29 |
| Time for Gelation (min.) | 0.8 | 0.7 | 0.7 | 0.5 | 0.4 | 0.4 | 0.4 | 0.4 |
| pH product | 3 | 3 | 3 | 3 | 3 | 3 | 3 | 3 |

As can be seen from Table 23, compositions of the present invention are capable of facilitating gelation times of less than 45 seconds, while also providing a relatively white product. Further, as noted by Examples 98 and 99, such compositions advantageously do not require the presence of a zinc compound for fast gelation to a white product.

### Examples 100-103

This set of examples illustrates embodiments of the invention where the elastomeric composition prepared can be a thermoset. To achieve this type of product, less processing oil was used as compared to formulations in the previous examples. First, for each of Examples 100-103, Trilene™ 77 was added to a glass beaker, followed by the addition of Kaydol™ BT-90 white mineral oil thereto in the proportions noted in Table 24. The material was preheated and stirred. Thereafter, the remaining materials indicated in Table 24 below were added to the mixture. The respective amounts (based on parts by weight of the composition) of each material in the mixture thus formed are also indicated in Table 24 below. Note that the phenolic resin was stored in a freezer until its addition to the mixture. This mixture was heated, with gentle manual stirring, to the temperature indicated in Table 24 using a Fisher Thermix™ Stirring Hot Plate; Model 210M. While a temperature of 180° C. was used for the reaction in Example 100, the temperature was decreased to 150° C. for subsequent Examples 101-103 because the reaction rate in Example 100 was so high that the product turned dark at the higher temperature.

Just before the composition developed into a thermoset, the contents of the beaker were transferred to a compression mold, which produced a thermoset part therefrom. The thermoset articles appeared to have excellent resiliency and snap back, properties which are typical of thermoset EPDM.

TABLE 24

| Material | Ex. 100 | Ex. 101 | Ex. 102 | Ex. 103 |
|---|---|---|---|---|
| Trilene ™ 77 | 50 | 60 | 75 | 80 |
| Kaydol ™ BT-90 | 50 | 40 | 25 | 20 |
| Zinc Oxide | 2.00 | 2.00 | 2.00 | 2.00 |
| Zinc Stearate 201 | 1.00 | 1.00 | 1.00 | 1.00 |
| SP-1045 | 3.00 | 3.00 | 3.00 | 3.00 |
| Magnesium Chloride | 2.50 | 2.50 | 2.50 | 2.50 |
| Stearic Acid | 0.50 | 0.50 | 0.50 | 0.50 |
| Oxalic Acid | 0.50 | 0.50 | 0.50 | 0.50 |
| Titanium Oxide | 1.00 | 1.00 | 1.00 | 1.00 |
| Temperature (° C.) | 180 | 150 | 150 | 150 |

As illustrated by this example, the catalyst systems are useful for preparing thermoset elastomeric compositions. Compared to conventionally prepared thermosets, catalyst systems of the invention facilitated much lower reaction times. Reaction times according to thermoset elastomeric compositions of the present invention, although variable, were in the range of 3-5 minutes. Compare those relatively short times to those typical of thermoset curing—15 to 30 minutes. Beneficially, the catalyst systems reduce reaction time in this process as well.

### Example 104

Some of the catalyst combinations developed using the beaker experiments in Examples 1-11 above were adopted for the preparation of a commercial elastomeric composition using a two-step approach. In the first step, the materials noted in Table 25 were run on a 30-millimeter twin screw extruder having an L/D ratio of 36: 1, fitted with a Gala™ underwater pelletizer (Gala Industries, Inc.; Eagle Rock, Va.; www.gala-industries.,com).

All of the materials were added in the main extruder hopper except for the processing oil, which was injected at room temperature down stream into the melt. The underwater pelletizer was run with cooling water at a temperature below 10° C. (50° F.). The extruder temperature profile was 150-175-180-190-190-175° C. (300-350-360-380-380-350° F.) and 175° C. (350° F.) at the throughput rate and rpm were adjusted to get to a residence time of 30 seconds by using a few pellets of a color concentrate to check residence time, before the samples were collected.

The following table shows the formulation that was run in this experiment to produce a PP-EPDM-oil master batch with other minor components.

TABLE 25

| | | Parts by Weight (%) |
|---|---|---|
| Material | How Added | Ex. 104 |
| Nordel ™ IP 4770 | Main hopper | 0 |
| Nordel ™ MG 47085 | | 32 |
| Nordel ™ MG 47130 | | 0 |
| PP 10-15 MFI | | 33 |
| Kaydol ™ BT-90 | Oil injection | 33 |
| Supersoft Hifax ™ 7320 | Main hopper | 2 |
| Kraton ™ G 1652 | | 2 |

At least 14 kg (30 lb.) of material from the master batch produced was collected in pellet form after reaching steady state. These pellets were then crosslinked subsequently (as described below) in a 25-mm Werner-Pfleiderer™ twin screw extruder (Coperion Corporation; Ramsey, N.J.) that had an L/D ratio of 44:1.

An oil pump was used to inject a molten mixture of the phenolic resin and oil at 100° C. (220° F.) at barrel 3, and devolatilization at barrel 9 with a vacuum pump. The barrel temperatures were set up as follows: 150-180-190-190-190-190-190-175-150° C. (300-360-380-380-380-380-380-350-300° F.) with die at 150° C. (300° F.). The residence time was adjusted to 90 seconds by slowing the feed rate and rpm. This long residence time was needed to complete the crosslinking reaction. The exact formulations run are described further in Table 26.

TABLE 26

| | | Parts by Weight (%) |
|---|---|---|
| Material | How Added | Ex. 104 |
| Example 104 | Main hopper | 80 |
| Zinc Oxide | Main hopper | 0.52 |
| Zinc Stearate 201 | Main hopper | 0.19 |
| Magnesium Chloride | Main hopper | 0.52 |
| Citric Acid | Main hopper | 0.25 |
| Irganox ™ 1010 | Main hopper | 0.10 |
| Tinuvin ™ 327 | Main hopper | 0.10 |
| Ultranox ™ 641 | Main hopper | 0.10 |
| Kaydol ™ BT-90 | Oil injection as a | 17.60 |
| S-1045 | molten mix at 110° C. | 0.62 |

### Examples 105-110

Another set of experiments was run on the same extruder as used in the second step of Example 104, except that the extruder was configured to have a slightly different screw configuration. In this case, all the components were added in one step and various elastomeric compositions were thus prepared.

A 25-mm Werner-Pfleiderer™ twin screw extruder (Coperion Corporation; Ramsey, N.J.) that had an L/D ratio of 44:1 was configured to have two oil pumps and two oil injection feeders for feeding oil at barrel 3 and feeding the mixture of 1 part by weight phenolic resin (SP-1055 or SP-1045) dissolved in 2 parts by weight oil at barrel 5/6. Devolatilization occurred at barrel 9 via a vacuum pump. Two feeders were set up at the main hopper, one with a large spiral for the elastomer and PP pellets (Feeder # 1) and another one for powders (Feeder # 2). All of the pellets were premixed together in one bag, while all of the powders were premixed together in another bag.

The temperature profile on the barrel was as follows: 150-175-180-190-190-175-165° C. (300-350-360-380-380-350-330° F.) with the die at 150° C. (300° F). The residence time was adjusted to 90 seconds by slowing both the feed rate and the screw rpm. This long residence time was needed in order to complete the crosslinking reaction. The formulations detailed in Table 27 were thus run.

TABLE 27

| | Parts by Weight (%) | | | | | | |
|---|---|---|---|---|---|---|---|
| | Ex. | Ex. | Ex. | Ex. | Ex. | Ex. | |
| TPV Formulation | 105 | 106 | 107 | 108 | 109 | 110 | Addition Point |
| EPDM w. 100% Oil (Royalene ™ | 43.30 | — | 45.00 | — | — | — | Barrel # 1 |
| X5494) pelletized | | | | | | | Feeder # 1 |
| Nordel ™ IP 4770P | — | 24.74 | — | 35.00 | — | — | |
| Nordel ™ MG 47085 - Black | — | — | — | — | 35.00 | 35.00 | |
| Pro-fax ™ 6823 | 9.80 | 9.80 | 5.00 | 5.00 | — | 10.00 | |
| PP1024E4 | 0.60 | 0.60 | 5.00 | 5.00 | 10.00 | — | |
| Kraton ™ G 1652 | 2.00 | 3.00 | 3.00 | 3.00 | 3.00 | 3.00 | |
| Hifax ™ CA10A | 4.30 | 9.10 | 5.00 | 5.00 | 5.00 | 5.00 | |
| Supersoft Hifax ™ 7350 | 4.00 | — | — | — | — | — | |
| Calcined Kaolin Clay | 9.50 | 9.50 | 4.50 | 4.50 | 4.50 | 4.50 | Barrel # 1 |
| Zinc Oxide | 2.16 | 2.16 | 2.00 | 2.00 | 2.00 | 2.00 | Feeder # 2 |
| Zinc Stearate 201 | 0.13 | 0.13 | 1.00 | 1.00 | 1.00 | 1.00 | |
| Calcium Stearate | 0.13 | 0.13 | — | — | — | — | |
| Citric Acid | — | — | 1.00 | 1.00 | 1.00 | 1.00 | |
| Stearic Acid | 0.13 | 0.13 | — | — | — | — | |
| Irganox ™ B-225 | 0.20 | 0.20 | 0.20 | 0.20 | 0.20 | 0.20 | |
| Tinuvin ™ P or Lowilite ™ 55 | 0.20 | 0.20 | 0.20 | 0.20 | 0.20 | 0.20 | |
| Titanium Dioxide | 0.65 | 0.65 | 1.60 | 1.60 | 0.10 | 0.10 | |
| Sodium Benzoate | 0.10 | 0.10 | 0.10 | 0.10 | 0.10 | 0.10 | |
| Magnesium Chloride | 2.00 | — | 2.00 | 2.00 | 2.00 | 2.00 | |
| Kaydol ™ BT-90 preheated to 100° C. | — | 33.56 | 19.60 | — | — | — | Barrel # 3/4 |
| Britol ™ 550 PO preheated to 100° C. | 16.00 | — | — | 29.60 | 31.10 | 31.10 | injected |
| Kaydol ™ BT-90 preheated to 100° C. | — | 4.50 | 2.40 | — | — | — | Barrel # 5/6 |
| Britol ™ 550 PO preheated to 100° C. | 2.40 | — | — | 2.40 | 2.40 | 2.40 | injected |
| SP-1045 | 2.40 | — | 2.40 | 2.40 | 2.40 | 2.40 | |
| SP-1055 | — | 1.50 | — | — | — | — | |

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited.

What is claimed is:

1. A catalyst system useful in preparing an elastomeric composition, the catalyst system comprising:
at least one phenolic resin;
at least one ingredient selected from the group consisting of a non-transition metal halide and a nanoclay;
optionally, at least one acid; and
optionally, at least one hydrogen halide scavenger,
wherein when the ingredient is nanoclay, the phenolic resin is brominated.

2. The catalyst system of claim 1, wherein the at least one phenolic resin comprises a non-brominated phenolic resin when the ingredient is the non-transition metal halide.

3. The catalyst system of claim 2, wherein the at least one phenolic resin comprises methylol groups.

4. The catalyst system of claim 1, wherein the catalyst system comprises at least one aliphatic acid, at least one aromatic acid, or combinations thereof.

5. The catalyst system of claim 1, wherein the catalyst system comprises at least one acid, wherein the acid comprises oxalic acid, citric acid, stearic acid, or combinations thereof

6. The catalyst system of claim 1, wherein the halide comprises magnesium chloride, calcium chloride, sodium chloride, potassium chloride, aluminum chloride, or combinations thereof.

7. A thermoplastic elastomer preparable using the catalyst system of claim 1.

8. An elastomeric composition comprising:
at least one elastomer;
optionally, at least one thermoplastic polymer, precursors for at least one thermoplastic polymer, at least one thermoset, or precursors for at least one thermoset polymer;
reacted in the presence of the catalyst system of claim 1,
wherein the elastomeric composition comprises a thermoplastic elastomer, a thermoset elastomer, or an elastomer.

9. A process for making an elastomeric composition, the process comprising:
providing a catalyst system of claim 1;
providing at least one uncured elastomer;
mixing components of the catalyst system, simultaneously or sequentially, with the uncured elastomer; and
heating the uncured elastomer in the presence of the catalyst system to form the elastomeric composition.

10. The process of claim 9, wherein the amount of the phenolic resin used is about 2 to about 10 percent by weight based on total weight of the uncured elastomer;
wherein the amount of the halide used is about 2 to about 8 percent by weight based on total weight of the uncured elastomer; and
wherein the amount of the acid used is about 1 to about 5 percent by weight based on total weight of the uncured elastomer.

11. The process of claim 9, wherein the elastomeric composition is prepared using reactive extrusion.
